(19) United States
(12) Patent Application Publication
(10) Pub. No.: US 2010/0056662 A1
(43) Pub. Date: Mar. 4, 2010

(54) RADIATION-CURABLE FORMULATION WHICH FORMS FLEXIBLE COATINGS WITH INCREASED CORROSION PROTECTION ON METALLIC SUBSTRATES

(75) Inventors: Emmanouil Spyrou, Schermbeck (DE); Thorsten Brand, Marl (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/440,927

(22) PCT Filed: Aug. 6, 2007
(86) PCT No.: PCT/EP2007/058106

§ 371 Date: Mar. 12, 2009

(30) Foreign Application Priority Data
Sep. 25, 2006 (DE) 102006045041.8

(51) Int. Cl. C08F 2/46; C08L 75/04

(52) U.S. Cl. 522/96; 524/590

(57) ABSTRACT

Radiation-curable formulations leading to flexible coatings with enhanced corrosion control on metal substrates.

The invention relates to radiation-curable formulations which in the cured state offer a particular degree of corrosion control for metallic substrates and at the same time are sufficiently flexible for deformation.

The invention relates to a radiation-curable formulation which in the cured state offer a particular degree of corrosion control for metallic substrates, and at the same time is sufficiently flexible for deformation.

Radiation-curable formulations are known.

Ethylenically unsaturated prepolymers are described for example in P.K.T. Oldring (ed.), “Chemistry and Technology of UV and EB Formulations for Coatings, Inks and Paints”, vol. II, SITA Technology, London 1991, based for example on epoxy acrylates (pages 31 to 68), urethane acrylates (pages 73 to 123), and melamine acrylates (pages 208 to 214). Formulations of this kind are frequently mentioned in the patent literature as well; examples include JP 62110779 and EP 947 565.

The coating of metallic substrates poses a particular problem for radiation-curable formulations, since processes of contraction may result in loss of adhesion. For such substrates it is therefore common to use adhesion promoters containing phosphoric acid. Examples of such are U.S. Pat. No. 5,128,387 (coating of beer cans) and JP 2001172554 (coating of various cans).

Epoxy acrylates are known to exhibit outstanding adhesion and effective corrosion control on metal substrates. A disadvantage of such coatings, however, is the low level of deformability after curing. For certain coating technologies, coil coating being one example, the deformability of the coated workpieces without the coating cracking is critical. WO 03/022945 describes low-viscosity radiation-curable formulations for metal substrates that are based on radiation-curable resins, monofunctional reactive diluents, and acidic adhesion promoters. The resins employed are commercial products of a variety of suppliers and are not specifically adapted for this purpose. In particular there is no mention of additional functional groups of the radiation-curing resins.

EP 902 040 as well embraces radiation-curable formulations. Described therein are urethane (meth)acrylates with monofunctional esters of an unsaturated carboxylic acid, which are esterified with alcohols containing a carbocyclic or a heterocyclic ring. No mention is made of any particular functionality of the urethane acrylates.

An object was to find radiation-curable formulations which on the one hand are readily deformable, i.e., flexible, after coating, but on the other hand also ensure outstanding corrosion control for metal substrates.

Surprisingly it has been found that the corrosion resistance of coating materials based on a radiation-curable formulation on metallic substrates increases if the radiation-curing resins employed possess free OH groups.

The present invention provides a radiation-curable formulation composed of
A) at least one radiation-curable polymer having an OH number ≧10 mg KOH/g, selected from the group of urethane (meth)acrylates, polyester (meth)acrylates, polyether (meth)acrylates, polycarbonate (meth)-acrylates and/or poly(meth)acrylate (meth)acrylates, and
B) at least one monofunctional radiation-curable reactive diluent,
C) at least one acidic adhesion promoter,
D) optionally photoinitiators,
E) optionally polyfunctional reactive diluents,
F) optionally other radiation-curable resins,
G) optionally pigments and other adjuvants.

The (meth)acrylates term includes both methacrylates and acrylates.

The preparation of radiation-curable resins is described for example in “Radiation Curing in Polymer Science & Technology, vol. I: Fundamentals and Methods” by J. P. Fouassier, J. F. Rabek, Elsevier Applied Science, London and New York, 1993, chapter 5, pages 226 to 236; in “Lackharze”, D. Stoye, W. Freitag, Hanser Verlag, Vienna, 1996; and in EP 0 947 565.

The radiation-curable polymers A) used in accordance with the invention have an OH number of at least 10 mg KOH/g, preferably from 10 to 50 mg KOH/g, more preferably from 10 to 25 mg KOH/g. The molar weight is between 500 and 15 000 g/mol.

Particular suitability is possessed by urethane (meth)acrylates on account of their particularly good mechanical and weather-stability properties. Urethane (meth)acrylates are described for example in U.S. Pat. No. 5,719,227.

Urethane (meth)acrylates are prepared from hydroxyl-containing polymers by reaction with polyisocyanates and with a compound which at one and the same time contains at least one isocyanate-reactive group (e.g., alcohol, amine or thiol) and at least one polymerizable acrylate group. They contain both urethane groups and acrylate groups.

Suitable hydroxyl-containing polymers include, in particular, polyesters, polyethers, polycarbonates, and polyacrylates. Polyesters are preferred on account of the physical properties of the material and on account of the breadth of application.

Hydroxyl-containing polyesters are prepared by polycondensation of suitable dicarboxylic acids and diols. The condensation takes place conventionally in an inert gas atmosphere at temperatures from 100 to 260° C., preferably 130 to 220° C., in the melt, or in azeotropic mode, as described for example in Methoden der Organischen Chemie (Houben-Weyl); volume 14/2, pages 1 to 5, 21 to 23, 40 to 44, Georg Thieme Verlag, Stuttgart, 1963, or in C. R. Martens, Alkyd Resins, pages 51 to 59, Reinhold Plastics Appl. Series, Reinhold Publishing Comp., New York, 1961. The carboxylic acids that are preferred for polyester preparation may be aliphatic, cycloaliphatic, aromatic and/or heterocyclic in nature and may if desired be substituted by halogen atoms and/or unsaturated. Examples thereof include the following: succinic, adipic, suberic, azelaic, sebacic, phthalic, terephthalic, isophthalic, trimellitic, pyromellitic, tetrahydrophthalic, hexahydrophthalic, hexahydroterephthalic, dichlorophthalic and tetrachlorophthalic, endomethylene tetrahydrophthalic, and glutaric acid, 1,4-cyclohexanedicarboxylic acid, and—where obtainable—their anhydrides or esters. Especially suitable are isophthalic acid, terephthalic acid, hexahydroterephthalic acid and 1,4-cyclohexanedicarboxylic acid.

Examples of suitable polyols include monoethylene glycol, 1,2- and 1,3-propylene glycol, 1,4- and 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)tricyclo[5.2.1.0^{2,6}]decane (Dicidol), 1,4-bis(hydroxymethyl)cyclohexane, 2,2-bis(4-hydroxycyclohexyl)propane, 2,2-bis[4-(β-hydroxyethoxy)phenyl]propane, 2-methylpropane-1,3-diol, 2-methyl-pentane-1,5-diol, 2,2,4(2,4,4)-trimethylhexane-1,6-diol, glycerol, trimethylolpropane, trimethylolethane, hexane-1,2,6-triol, butane-1,2,4-triol, tris(β-hydroxyethyl)isocyanurate, penta-erythritol, mannitol, and sorbitol, and also diethylene glycol, triethylene glycol, tetraethylene glycol, dipropylene glycol, polypropylene glycols, polybutylene glycols, xylylene glycol, and neopentyl glycol hydroxypivalate. Preference is given to monoethylene glycol, neopentyl glycol, Dicidol, cyclohexanedimethanol, trimethylolpropane, and glycerol.

Polyesters prepared in this way have an OH number of 15 to 750 mg KOH/g. Mixtures of polyesters can be used as well.

For preparing urethane acrylates the polyisocyanates used are diisocyanates of aliphatic, (cyclo)aliphatic or cycloaliphatic structure. Representative examples of the polyisocyanates are 2-methylpentamethylene 1,5-diisocyanate (MPDI), hexamethylene diisocyanate (HDI), trimethylhexamethylene 1,6-diisocyanate (TMDI), in particular 2,2,4- and the 2,4,4 isomer and technical mixtures of both isomers, 4,4′-methylenebis(cyclohexyl isocyanate) (H₁₂MDI), norbornane diisocyanate (NBDI), and 3,3,5-trimethyl-1-isocyanato-3-isocyanatomethyl-cyclohexane (IPDI). Likewise highly suitable as well are polyisocyanates which are obtainable by reacting polyisocyanates with themselves via isocyanate groups, such as isocyanurates, which come about through reaction of three isocyanate groups. The polyisocyanates may likewise contain biuret groups or allophanate groups. IPDI and/or IPDI trimer is especially suitable.

Examples of suitable polymerizable compounds having at least one free OH group and a polymerizable (meth)acrylate group include hydroxyethyl (meth)acrylate (HEA or HEMA, respectively), hydroxypropyl (meth)acrylate, hydroxybutyl (meth)acrylate, and glycerol di(meth)acrylate. Particular suitability is possessed by hydroxyethyl acrylate (HEA).

To prepare the urethane acrylate from the OH-containing polymers, polyisocyanates, and the acrylate component, first of all the polyisocyanate is introduced, a suitable catalyst (e.g., DBTL) and a polymerization inhibitor (e.g., IONOL CP, Shell) are added, and the acrylate component, hydroxyethyl acrylate for example, is added in an NCO:OH ratio of 2.5 to 1:1. Thereafter the polyester is added to the reaction product, in a residual NCO:OH ratio of 0.5 to 0.95:1, and the reaction is completed at 40 to 120° C., so that an NCO content below 0.1% is obtained and the OH number of this product is at least 10 mg KOH/g.

The reaction of hydroxyl-containing polymers with (meth)acrylic acid and/or esters thereof is described for example in DE 39 22 875 or else in U.S. Pat. No. 6,090,866. Generally for that purpose the polymers, with or without solvent, are heated at temperatures of between 80 and 160° C. with (meth)acrylic acid and/or esters thereof in the presence of a polymerization inhibitor and of a (usually acidic) catalyst, the water (or alcohol) of reaction formed by the esterification (or transesterification, respectively) being removed by distillation. When the desired conversion is at an end, the residual (meth)acrylic acid (and/or esters thereof) can be separated off under reduced pressure at lower temperatures. In accordance with the invention the reaction is ended before the OH number of the resulting product drops below 10, and the reaction mixture is worked up as described above.

The preparation of polyethers is described for example in Stoye, Freitag, Lackharze, Carl-Hanser Verlag, pp. 206, 207. Such polyethers are available commercially under the trade names Lupranol (BASF), Desmophen U (Bayer), Voranol (DOW), Sovermol (Henkel), PolyTHF (BASF), and Terathane (DuPont).

The preparation of polycarbonates is described in, for example, Stoye, Freitag, Lackharze, Carl-Hanser Verlag, pages 103, 104. Commercial products are, for example, PolyTHF CD (BASF), Desmophen C200 (Bayer).

The preparation of poly(meth)acrylates is described for example in Stoye, Freitag, Lackharze, Carl-Hanser Verlag, pages 316 to 320. Commercial products are for example Acronal, Luprenal (BASF), Acryloid (Rohm & Haas), Desmophen A (Bayer), Joncryl (Johnson), Plexigum, Plexisol (Röhm) and many others.

The amount of A) in the formulation varies from 5% to 95% by weight, preferably 10% to 39% by weight.

Radiation-curable monofunctional reactive diluents B) and their preparation are described for example in “Radiation Curing in Polymer Science & Technology, Vol. I: Fundamentals and Methods” by J. P. Fouassier, J. F. Rabek, Elsevier Applied Science, London and New York, 1993, chapter 5, pages 237 to 240. They are generally acrylates or methacrylate substances which are liquid at room temperature and hence capable of lowering the overall viscosity of a formulation. Examples of such products are isobornyl acrylate, hydroxypropyl methacrylate, trimethylolpropane formal monoacrylate, tetrahydrofurfuryl acrylate, phenoxyethyl acrylate, lauryl acrylate, and also propoxylated or ethoxylated versions of these reactive diluents, and also urethanized reactive diluents such as Ebecryl 1039 (Cytec), and others. Also suitable as well are other liquid components which are capable of reacting under free-radical polymerization conditions, such as vinyl ethers or allyl ethers, for example.

The amount of B) in the formulation is 5% to 90% by weight, preferably from 30% to 61% by weight.

Adhesion promoters C) for radiation-curable formulations for metallic substrates are generally composed of phosphoric acid or phosphonic acid or their reaction products (e.g., esters) with functionalized acrylates. While the free phosphoric acid groups are responsible for the direct adhesion to the metal, the acrylate groups ensure a bond with the coating matrix. Products of this kind are also described in WO 01/98413, in JP 08231564, and in JP 06313127.

Typical commercial products are EBECRYL 169 and 170 from Cytec, ALDITOL Vxl 6219 from VIANOVA, CD 9050 and CD 9052 from Sartomer, SIPOMER PAM-100, SIPOMER PAM-200, and SIPOMER PAM-300 from Rhodia, and GENORAD 40 from Rahn. The amount of C) in the formulation is 0.1% to 10% by weight, preferably from 0.5% to 5% by weight.

Photoinitiators D) and their preparation are described for example in “Radiation Curing in Polymer Science & Technology, Vol. II: Photoinitiating Systems” by J. P. Fouassier, J. F. Rabek, Elsevier Applied Science, London and New York, 1993. Photoinitiators may be present if appropriate in amounts from 0.2% to 10% by weight, preferably from 1% to 8% by weight.

Radiation-curable polyfunctional reactive diluents E) and their preparation are described for example in “Radiation Curing in Polymer Science & Technology, Vol. I: Fundamentals and Methods” by J. P. Fouassier, J. F. Rabek, Elsevier Applied Science, London and New York, 1993, chapter 5, pages 237 to 240. They are generally acrylate or methacrylate substances which are liquid at room temperature and hence capable of lowering the overall viscosity of the formulation. Examples of such products are trimethylenepropane triacrylate, dipropylene glycol diacrylate, tripropylene glycol diacrylate, hexanediol diacrylate, and pentaerythritol tetraacrylate. The amount of E) in the formulation is 1% to 50% by weight, preferably from 1% to 20% by weight, if present.

The preparation of radiation-curable resins F) is described for example in “Radiation Curing in Polymer Science & Technology, Vol. I: Fundamentals and Methods” by J. P. Fouassier, J. F. Rabek, Elsevier Applied Science, London and New York, 1993, chapter 5, pages 226 to 236; in “Lackharze”, D. Stoye, W. Freitag, Hanser-Verlag, Vienna, 1996; and in EP 947 565. The amount of F in the formulation is 1% to 50% by weight, preferably 1-20% by weight, if present.

Suitable pigments G) in radiation-curable formulations are described for example in “Radiation Curing in Polymer Science & Technology, Vol. IV: Practical Aspects and Application” by J. P. Fouassier, J. F. Rabek, Elsevier Applied Science, London and New York, 1993, chapter 5, pages 87 to 105, and may be present in amounts from 1% to 40% by weight. Examples of anticorrosion pigments are found for example in “Pigment+Füllstoff Tabellen”, O. Lückert, Vincentz Verlag, Hanover, 6th edition 2002. Examples include the following: SHIELDEX C 303 (Grace Davison) and HALOX Coil X 100, HALOX Coil X 200, and HALOX CW 491 (Erbslöh), HEUCOPHOS SAPP or else ZPA (Heubach), K-White TC 720 (Tayca), and HOMBICOR (Sachtleben). Of course, simple inorganic salts such as zinc phosphate, for example, are also suitable.

Other adjuvants G) for radiation-curable formulations are available in various compositions and for diverse purposes, examples being flow control agents, matting agents, degassing agents, etc.

Some of them are described in the brochure “SELECTED DEGUSSA PRODUCTS FOR RADIATION CURING AND PRINTING INKS”, published by Tego Coating & Ink Additives, Essen, 2003. The amount of such additives varies from 0.01% to 5% by weight, if present.

The radiation-curable formulation of the invention may be applied by techniques that are known within coatings technology, such as knife coating, rolling, spraying or injecting, for example.

The most suitable metallic substrate is steel, optionally pretreated, but suitability as metallic substrate is also possessed by aluminum and other metals or alloys that are given a coating on grounds of corrosion control.

The curing takes place in the presence of photoinitiators under UV irradiation or in the absence of photoinitiators under electron beams. The properties of the cured coating materials are largely independent of the curing method.

UV curing and UV lamps are described for example in “Radiation Curing in Polymer Science & Technology, Vol. I: Fundamentals and Methods” by J. P. Fouassier, J. F. Rabek, Elsevier Applied Science, London and New York, 1993, chapter 8, pages 453 to 503.

Electron-beam (EB) curing and EB curers are described for example in “Radiation Curing in Polymer Science & Technology, Vol. I: Fundamentals and Methods” by J. P. Fouassier, J. F. Rabek, Elsevier Applied Science, London and New York, 1993, chapter 4, pages 193 to 225 and chapter 9, pages 503 to 555.

The invention also provides coatings comprising a radiation-curable formulation composed of
A) at least one radiation-curable polymer having an OH number ≧10 mg KOH/g, selected from the group of urethane (meth)acrylates, polyester (meth)acrylates, polyether (meth)acrylates, polycarbonate (meth)-acrylates and/or poly(meth)acrylate (meth)acrylates, and
B) at least one monofunctional radiation-curable reactive diluent,
C) at least one acidic adhesion promoter,
D) optionally photoinitiators,
E) optionally polyfunctional reactive diluents,
F) optionally other radiation-curable resins,
G) optionally pigments and other adjuvants.

The coating of the invention can be used either on its own or as a primer in a multicoat system. The coats above the coating of the invention may be cured either conventionally, thermally, or else by means of radiation.

The invention is elucidated below with reference to examples, but not in such a way as to restrict it.

### EXAMPLES

| Ingredients | Product description, manufacturer |
|---|---|
| IPDI | Isophorone diisocyanate, Degussa AG, |
| | Coatings & Colorants, |
| | NCO content: 37.8% |
| HEA | Hydroxyethyl acrylate, Röhm |
| IBOA | Isobornyl acrylate, Cytec, |
| | monofunctional reactive diluent |
| Ionol CP | Polymerization inhibitor, Shell |
| ADDITOL VXL 6219 | Adhesion promoter containing |
| | phosphoric acid, Sartomer |
| IRGACURE 184 | Photoinitiator, Ciba |
| HDDA | Hexanediol diacrylate, Cytec, |
| | difunctional reactive diluent |
| DBTL | Dibutyltin dilaurate |

### I. Preparation Instructions: Hydroxyl-Containing Polyester P

Adipic acid (315 g, 2.2 mol), phthalic anhydride (192 g, 1.3 mol), isophthalic acid (143 g, 0.9 mol), hexane-1,6-diol (231 g, 2.0 mol), neopentyl glycol (171 g, 1.6 mol), and monoethylene glycol (96 g, 1.5 mol) are melted in a stream of nitrogen in a 1.5 l flask with column and top-mounted distillation unit, and heating is continued. When a temperature of approximately 160° C. is reached in the liquid phase in the flask, water begins to distill off. Over the course of two hours the temperature is increased successively to 230° C. After about two more hours at this temperature there is a slowing in the production of distillate. 0.2 g of n-butyltin trioctoate is added and reaction is continued under reduced pressure, which in the course of the reaction is adjusted so that distillate continues to be produced. Reaction is discontinued when a hydroxyl number of 72 mg KOH/g and an acid number of 0.6 mg KOH/g are reached. DSC measurement (second heating) puts the glass transition temperature, T_{g}, of the polyester at −38° C.

### II. Preparation of the IPDI-HEA Adduct

A mixture of 222.0 g (1 mol) of IPDI, 0.7 g of IONOL CP, and 0.4 g of DBTL was admixed dropwise and with stirring with 116.0 g (1 mol) of hydroxyethyl acrylate. After a further 30 minutes of stirring at 60° C. the NCO content was 12.2% and the reaction mixture was cooled.

III. Preparation of urethane acrylates UA1 to UA3

779.2 g (1 equivalent of OH) of the hydroxyl-containing polyester P were heated to 80° C. and admixed in portions with the following amounts of IPDI-HEA adduct from example II. After 2 hours the reaction is at an end and the NCO number is <0.1%.

UA1: 206.6 g (0.6 equivalent of NCO)
OHN 22.8 mg KOH/g

UA2: 275.4 g (0.8 equivalent of NCO)
OHN 10.6 mg KOH/g

UA3: 344.3 g (1.0 equivalent of NCO)
OHN 0 mg KOH/g (comparative example)
   IV. Formulations with Monofunctional Reactive Diluents (UA1-2: Inventive; UA3: Noninventive Comparison)

The urethane acrylates (UA1-UA3) were stirred together thoroughly with the other formulation constituents. After the pigments had been added, the formulations were further dispersed in a Dispermat at 9000 rpm for 20 minutes. Finally, the serviceable formulations were applied by knife coating to steel panels (pretreated steel panels, Chemetall, Bonder 1303) and subsequently cured under a UV lamp (3 m/min, Minicure, mercury vapor lamp, 80 W/cm, Technigraf).

Formulation: 35% urethane acrylate UA1-3, 50% IBOA, 3% IRGACURE 184, 2% ADDITOL VXL 6219, and 10% zinc phosphate.

### a) One-Coat Finish:

The formulations IV were applied by knife coating in a film thickness of 20 μm to Bonder 1303 steel panels (pretreated steel panels, Chemetall) and cured as described. Thereafter the panels were subjected to an Erichsen cupping (DIN 53 156) and a salt spray test (DIN 53167) and were assessed after 360 hours. The results obtained were as follows:

Salt spray test

| | Erichsen cupping | Creep | |
|---|---|---|---|
| Da_UA1: | 10.0 mm | 4.9 mm | (inventive) |
| Da_UA2: | 10.0 mm | 4.4 mm | (inventive) |
| Da_UA3: | 8.5 mm | 10.1 mm | (comparative) |

The positive effect of the additional OH groups on the corrosion resistance is clearly apparent.

### b) Two-Coat Finish:

The formulations IV were applied by knife coating in a film thickness of 5 μm to Bonder 1303 steel panels (pretreated steel panels, Chemetall) and cured as described. Then a solventborne PU topcoat SP 31 (Degussa AG, for composition see below) was applied by knife coating and baked at 232° C. PMT (Peak Metal Temperature). Thereafter the panels were subjected to an Erichsen cupping and a salt spray test (500) h. The results obtained were as follows:

Salt spray test

| | Erichsen cupping | Creep | |
|---|---|---|---|
| Db_UA1: | 8.0 mm | 0.1 mm | (inventive) |
| Db_UA2: | 7.5 mm | 0.3 mm | (inventive) |
| Db_UA3: | 7.5 mm | 0.8 mm | (comparative) |

The positive effect of the additional OH groups on the corrosion resistance is clearly apparent.

All of the cured films tested in IV had an Erichsen cupping of at least 5 mm, and are therefore sufficiently flexible for typical applications.

Guideline formulation for solventborne, polyurethane-based topcoat materials SP 31:

### 35.6 DYNAPOL LH 748-02 (Degussa AG)

### 0.2 AEROSIL 200 (Degussa AG)

28.5 Titanium dioxide 2310 (Kronos)
4.0 DBE (Dibasic ester, paint solvent)
4.0 butyl diglycol acetate

Bead mill, pigments ground to 10 to 12 μm

### 3.5 ACEMATT OK 500 (Degussa AG)

### 3.0 DYNAPOL LH 748-02 (Degussa AG)

1.1 DISPARLON 1983/50% in SN 200 (Erbslöh)
0.5 VESTICOAT catalyst C 31 (Degussa AG)

### 9.4 DESMODUR BL 3175 (Bayer)

4.2 Butyl glycol
6.0 Butyl diglycol acetate
100 parts

### Baking Conditions

Baking time: 30 seconds

### PMT: 232° C.

Film thickness: approximately 20 μm
V. Formulation without Monofunctional Reactive Diluents (Noninventive, Comparative Examples)

The urethane acrylates (UA1-UA3) were stirred together thoroughly with the other formulation constituents. After the pigments had been added, the formulations were further dispersed in a Dispermat at 9000 rpm for 20 minutes. Finally, the serviceable formulations were applied by knife coating with a film thickness of 20 μm to steel panels (pretreated steel panels, Chemetall, Bonder 1303) and subsequently cured under a UV lamp (3 m/min, Minicure, mercury vapor lamp, 80 W/cm, Technigraf).

Formulation: 35% urethane acrylate UA1-3, 50% HDDA, 3% IRGACURE 184, 2% ADDITOL VXL 6219, and 10% zinc phosphate.

| | Erichsen cupping | |
|---|---|---|
| E_UA1: | 3.5 mm | (comparative example) |
| E_UA2: | 3.2 mm | (comparative example) |
| E_UA3: | 2.4 mm | (comparative example) |

The Erichsen cupping of all three comparative formulations was less than 5 mm. Consequently these films, without monofunctional reactive diluents, are not sufficiently flexible for typical applications.

1. A radiation-curable formulation comprising
A) at least one radiation-curable polymer having an OH number ≧10 mg KOH/g, selected from the group consisting of urethane (meth)acrylates, polyester (meth)-acrylates, polyether (meth)acrylates, polycarbonate (meth)acrylates and poly(meth)acrylate (meth)acrylates, and
B) at least one monofunctional radiation-curable reactive diluent, and
C) at least one acidic adhesion promoter.

2. The radiation-curable formulation according to claim 1, wherein component A) has an OH number of at least 10 mg KOH/g, and a molar mass from 500 to 15 000 g/mol.

3. The radiation-curable formulation according to claim 1, wherein urethane acrylates are present as component A).

4. The radiation-curable formulation according to claim 1, wherein urethane (meth)acrylates
obtained from hydroxyl-containing polymers by reaction with polyisocyanates and with a compound which has at least one isocyanate-reactive group and at least one polymerizable acrylate group
are present as component A).

5. The radiation-curable formulation according to claim 4, wherein polyesters, polyethers, polycarbonates, and polyacrylates are used as hydroxyl-containing polymers.

6. The radiation-curable formulation according to claim 5, wherein succinic acid, adipic acid, suberic acid, azelaic acid, sebacic acid, phthalic acid, terephthalic acid, isophthalic acid, trimellitic acid, pyromellitic acid, tetrahydrophthalic acid, hexahydrophthalic acid, hexahydroterephthalic acid, dichlorophthalic acid, tetrachlorophthalic acid, endomethylene tetrahydrophthalic acid, glutaric acid, 1,4-cyclo-hexanedicarboxylic acid, anhydrides thereof, and esters thereof are used as carboxylic acids for the polyester.

7. The radiation-curable formulation according to claim 5, wherein at least one of monoethylene glycol, 1,2-propylene glycol, 1,3-propylene glycol, 1,4-butylene glycol, 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)tricyclo[5.2.1.0^{2,6}]decane (Dicidol), 1,4-bis(hydro-oxymethyl)cyclohexane, 2,2-bis(4-hydroxycyclo-hexyl)propane, 2,2-bis[4-(β-hydroxyethoxy)phenyl]-propane, 2-methylpropane-1,3-diol, 2-methyl-pentane-1,5-diol, 2,2,4(2,4,4)-trimethyl-hexane-1,6-diol, glycerol, trimethylolpropane, trimethylolethane, hexane-1,2,6-triol, butane-1,2,4-triol, tris(β-hydroxyethyl)isocyanurate, pentaerythritol, mannitol, sorbitol, diethylene glycol, triethylene glycol, tetraethylene glycol, dipropylene glycol, polypropylene glycols, polybutylene glycols, xylylene glycol neopentyl glycol hydroxypivalate are used as polyols for the polyester.

8. The radiation-curable formulation according to claim 1, wherein at least one of 2-methylpentamethylene 1,5-diisocyanate, hexamethylene diisocyanate trimethylhexamethylene 1,6-diisocyanate, especially the 2,2,4 and the 2,4,4 isomer and technical mixtures of both isomers, 4,4′-methylenebis(cyclohexyl isocyanate), norbornane diisocyanate, and 3,3,5-trimethyl-1-isocyanato-3-isocyanatomethyl-cyclohexane, are used as diisocyanates or polyisocyanates for obtaining the urethane acrylates.

9. The radiation-curable formulation according to claim 8, wherein isocyanurates are used.

10. The radiation-curable formulation according to claim 1, wherein at least one of hydroxyethyl (meth)acrylate, hydroxypropyl (meth)acrylate, hydroxybutyl (meth)acrylate, and glycerol di(meth)acrylate are used as polymerizable compounds having at least one free OH group and a polymerizable (meth)acrylate group.

11. A The radiation-curable formulation according to at claim 1, wherein component A) is present in an amount of from 5% to 95% by weight.

12. The radiation-curable formulation according to at claim 1, wherein at least one of isobornyl acrylate, hydroxypropyl methacrylate, trimethylolpropane formal monoacrylate, tetrahydro furfuryl acrylate, phenoxyethyl acrylate, lauryl acrylate, and propoxylated or ethoxylated variants of these reactive diluents, urethanized reactive diluents, vinyl ethers or allyl ethers, are present as component B) in amounts an amount of from 5% to 90% by weight.

13. The radiation-curable formulation according to at claim 1, wherein at least one of phosphoric acid and phosphonic acid or their reaction products with functionalized acrylates are present as component C) in an amount of from 0.1 to 10% by weight.

14. A The radiation-curable formulation according to at claim 1, further comprising photoinitiators D) that are present in an amount of from 0.1% to 10% by weight.

15. The radiation-curable formulation according to at claim 1, wherein trimethylenepropane triacrylate, dipropylene glycol diacrylate, tripropylene glycol diacrylate, hexanediol diacrylate, and penta-erythritol tetraacrylate are used as component E) in amounts from 1% to 50% by weight.

16. The coating comprising a radiation-curable formulation comprising
A) at least one radiation-curable polymer having an OH number ≧10 mg KOH/g, selected from the group of urethane (meth)acrylates, polyester (meth)-acrylates, polyether (meth)acrylates, polycarbonate (meth)acrylates and/or poly-(meth)acrylate (meth)acrylates, and
B) at least one monofunctional radiation-curable reactive diluent,
C) at least one acidic adhesion promoter.

17. The coating comprising a radiation-curable formulation according to claim 16, further comprising:
at least one photoinitiator,
at least one polyfunctional reactive diluent,
at least one radiation curable resin,
at least one pigment, and
at least one adjuvant.

18. The radiation-curable formulation according to claim 15, component E) is present in an amount of from 1% to 20% by weight.

19. The radiation-curable formulation according to claim 14, wherein said photoinitiators D) are present in an amount of from 1% to 8% by weight.

20. The radiation-curable formulation according to claim 1, wherein component A) has an OH number of from 10 to 50 mg KOH/g and a molar mass from 500 to 15 000 g/mol.

21. The radiation-curable formulation according to claim 1, wherein component A) has an OH number of from 10 to 25 mg KOH/g and a molar mass from 500 to 15 000 g/mol.

22. The radiation-curable formulation according to claim 1, wherein component A) is present in an amount of from 10% to 39% by weight.

23. The radiation-curable formulation according to claim 1, wherein at least one of isobornyl acrylate, hydroxypropyl methacrylate, trimethylolpropane formal monoacrylate, tetrahydrofurfuryl acrylate, phenoxyethyl acrylate, lauryl acrylate, and propoxylated or ethoxylated variants of these reactive diluents, urethanized reactive diluents, vinyl ethers or allyl ethers, are present as component B) in an amount of from 30% to 61% by weight.

24. The radiation-curable formulation according to claim 1, wherein at least one of phosphoric acid and phosphonic acid or their reaction products with functionalized acrylates are present as component C) in an amount of from 0.5 to 5% by weight.

25. The radiation-curable formulation according to claim 1, further comprising photoinitiators D) that are present in an amount of from 1% to 8% by weight.

26. The radiation-curable formulation according to claim 1, wherein trimethylenepropane triacrylate, dipropylene glycol diacrylate, tripropylene glycol diacrylate, hexanediol diacrylate, and penta-erythritol tetraacrylate are used as component E) in amounts from 1% to 20% by weight.
